(19) United States
(12) Patent Application Publication
(10) Pub. No.: US 2012/0046390 A1
(43) Pub. Date: Feb. 23, 2012

(54) EPOXY RESIN COMPOSITION

(76) Inventors: Jui-Hung Chen, Taoyuan County (TW); Cheng-Chung Liao, Taoyuan County (TW)

(21) Appl. No.: 13/044,203

(22) Filed: Mar. 9, 2011

(30) Foreign Application Priority Data
Aug. 18, 2010 (TW) 099127566

(51) Int. Cl. C08L 63/00

(52) U.S. Cl. 523/443; 523/400; 523/466; 523/457

(57) ABSTRACT

An epoxy resin composition has a glass transition temperature between 20° C. and 75° C. The epoxy resin composition includes an epoxy resin, a plurality of water vapor-proof particles, and at least two kinds of amino-functional curing agents. One of the amino-functional curing agents is a polyamine-type curing agent. The weight percent of the curing agent corresponding to the epoxy resin is between 10% and 95%.

### BACKGROUND OF THE INVENTION

1. Field of the Invention

This invention generally relates to an epoxy resin composition. More particularly, this invention relates to an epoxy resin composition serving as a packaging material.

2. Description of the Prior Art

Conventional epoxy packaging materials for display devices after being thermally cured will have high glass transition temperature (Tg) and become inflexible. Various methods for decreasing the Tg of epoxy resin and preparing the low Tg epoxy resin composition to take advantage of its characteristics are proposed. For example, U.S. Pat. No. 6,632,893 B2 discloses using a mixture of cyanate ester component and imidazole component as the curing agent for epoxy resin, wherein a polysulfide-based toughening agent is added. The epoxy resin composition has a Tg between 130° C. and 132° C. In addition, U.S. Pat. No. 6,893,736 B2 discloses using a mixture of modified amide and latent catalyst therefor as the curing agent for epoxy resin, wherein a polysulfide-based toughening agent and a transition metal complex are added. The epoxy resin composition has a Tg between 62° C. and 109° C. The above disclosed techniques are complex in composition and abundant in preparing steps that are still improvable.

### SUMMARY OF THE INVENTION

The present invention is to provide an epoxy resin composition serving as a packaging material, wherein the epoxy resin composition has low glass transition temperature.

The epoxy resin composition of the present invention having a glass transition temperature between 20° C. and 75° C. includes an epoxy resin, a plurality of water vapor-proof particles, and at least two kinds of amino-functional curing agents, wherein one of the amino-functional curing agents is a polyamine-type curing agent. The weight percent of the amino-functional curing agents corresponding to the epoxy resin is between 10% and 95%.

In a preferred embodiment, the amino-functional curing agents further include a composite amino-functional curing agent. The epoxy resin composition further includes a coupling agent, a leveling agent, a defoaming agent, or a combination thereof.

The water vapor-proof particle is selected from silica, aluminum oxide, clay, mica, or a combination thereof. The water vapor-proof particles include a plurality of first silica particles having an average diameter of 30 μm and a plurality of second silica particles having an average diameter of 100 nm. The weight percent of the second silica particles corresponding to the first silica particles is between 0.1% and 50%, preferably between 1% and 40%, and more preferably between 3% and 30%.

The water vapor-proof particles further include a plurality of third silica particles having an average diameter between 200 nm and 500 nm. The weight percent of the third silica particles corresponding to the first silica particles is between 0.1% and 50%, preferably between 1% and 40%, and more preferably between 3% and 30%. The water vapor-proof particles further include a plurality of fourth silica particles having an average diameter between 500 nm and 800 nm. The weight percent of the fourth silica particles corresponding to the first silica particles is between 0.1% and 50%, preferably between 1% and 40%, and more preferably between 3% and 30%.

### BRIEF DESCRIPTION OF THE DRAWINGS

FIG. 1 is an embodiment of the present invention.

### DETAILED DESCRIPTION OF THE PREFERRED EMBODIMENT

The epoxy resin composition of the present invention having a glass transition temperature between 20° C. and 75° C. includes an epoxy resin, a plurality of water vapor-proof particles, and at least two kinds of amino-functional curing agents, wherein one of the amino-functional curing agents is a polyamine-type curing agent. The weight percent of the amino-functional curing agents corresponding to the epoxy resin is between 10% and 95%, preferably between 12% and 80%, and more preferably between 15% and 60%. The weight percent of the polyamine type curing agent corresponding to the amino-functional curing agents is between 30% and 95%, preferably between 35% and 90%, and more preferably between 40% and 85%.

In a preferred embodiment, the chlorine content of the epoxy resin is lower than 900 ppm to satisfy the requirement of being environmentally friendly. The amino-functional curing agents further include a composite amino-functional curing agent. More particularly, the curing effect can be increased if the amino-functional curing agents having the polyamine-type curing agent further include the composite amino-functional curing agent. In other embodiments, however, the epoxy resin composition of the present invention may further include imidazole curing agent to increase the curing effect.

The water vapor-proof particle is selected from silica, aluminum oxide, clay, mica, or a combination thereof. In a preferred embodiment, the water vapor-proof particles are selected from silica and include a plurality of first silica particles having an average diameter of 30 μm and a plurality of second silica particles having an average diameter of 100 nm. The weight percent of the second silica particles corresponding to the first silica particles is between 0.1% and 50%, preferably between 1% and 40%, and more preferably between 3% and 30%. The water vapor-proof particles further include a plurality of third silica particles having an average diameter between 200 nm and 500 nm, wherein the weight percent of the third silica particles corresponding to the first silica particles is between 0.1% and 50%, preferably between 1% and 40%, and more preferably between 3% and 30%. The water vapor-proof particles further include a plurality of fourth silica particles having an average diameter between 500 nm and 800 nm, wherein the weight percent of the fourth silica particles corresponding to the first silica particles is between 0.1% and 50%, preferably between 1% and 40%, and more preferably between 3% and 30%.

In a preferred embodiment, the epoxy resin composition further includes a coupling agent, a leveling agent, a defoaming agent, or a combination thereof. The coupling agent can be silane coupling agent and is preferably epoxy-alkoxysilane represented by the formula of R(CH₂)ₙSi(R′)₄₋ₘ, wherein R is epoxy group, n is between 1 and 10, R′ may be an alkoxy group having 1 to 4 carbon atoms, m may be 1, 2, or 3. The leveling agent includes but not limited to polyacrylate polymer or polyacrylate copolymer. Corresponding to 100 weights of epoxy resin, the weights of the leveling agent are preferably between 0.001 and 5, and more preferably between 0.01 and 2. The defoaming agent includes but not limited to polysiloxane polymer or modified polysiloxane polymer. Corresponding to 100 weights of epoxy resin, the weights of the defoaming agent are preferably between 0.001 and 5, and more preferably between 0.01 and 2.

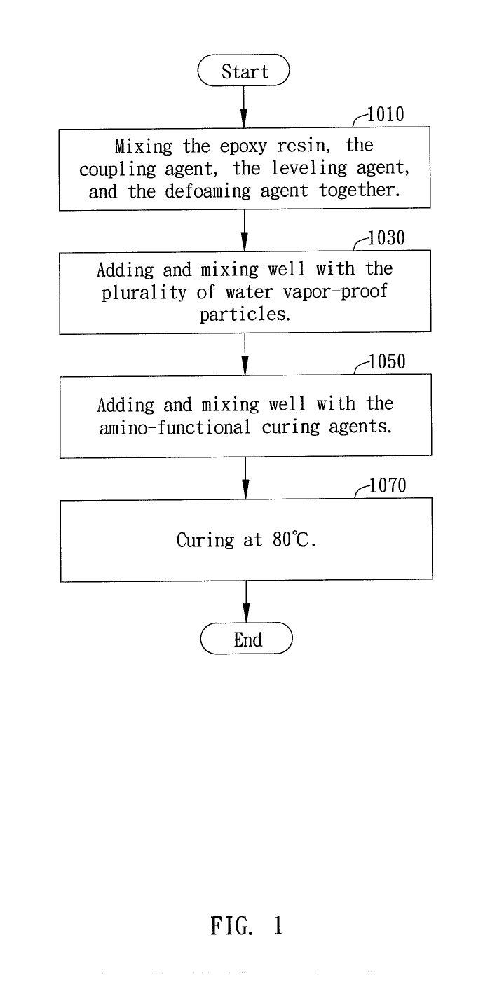

As shown in FIG. 1, the epoxy resin composition of the present invention is preferably prepared by the following steps: step 1010 of mixing the above mentioned epoxy resin, coupling agent, leveling agent, and defoaming agent together; step 1030 of adding and mixing with the above mentioned plurality of water vapor-proof particles, wherein the step is preferably performed by use of a three roll mill; step 1050 of adding and mixing with the amino-functional curing agents, wherein the step is preferably performed by use of a three roll mill; and step 1070 of curing at 80° C.

The effect of the epoxy resin composition of the present invention is illustrated in the following different embodiments.

[Embodiment 1]

32.2 g of bisphenol-A type epoxy resin (850CRP, DIC Corporation, Japan), 13.8 g of bisphenol-F type epoxy resin (830CRP, DIC Corporation, Japan), 4.0 g of epoxy-alkoxysilane coupling agent (KBM-403, Shin-Etsu Chemical Co., Ltd., Japan), 0.4 g of leveling agent (BYK360P:BYK362P=1:1, BYK-Chemie GmbH, Germany), and 0.2 g of defoaming agent (BYK141A, BYK-Chemie GmbH, Germany) are put in a mixer. After mixing well, water vapor-proof particles including 16.6 g of first silica particles (sphere with average diameter of 30 μm, KMP-602, Shin-Etsu Chemical Co., Ltd., Japan) and 2.4 g of second silica particles (sphere with average diameter of 100 nm, UFP-30, DENKI KAGAKU KOGYO KABUSHIKI KAISHA Corp., Japan) are added, wherein the mixture is milled by use of a three roll mill for the first time. After the first-time milling is completed, amino-functional curing agents include 16 g of polyamine type curing agent (ARADUR, Huntsman International LLC., U.S.A.) and 4.0 g of composite amino-functional curing agent (EH-4337S, ASATSU-DK INC., Japan) are added, wherein the mixture is milled by use of a three roll mill for the second time. After the second-time milling is completed, the mixture is heated at 80° C. for 30 minutes to obtain a cured epoxy resin composition of the present invention.

[Embodiment 2]

13.8 g of bisphenol-A type epoxy resin (850CRP, DIC Corporation, Japan), 32.2 g of bisphenol-F type epoxy resin (830CRP, DIC Corporation, Japan), 4.0 g of epoxy-alkoxysilane coupling agent (KBM-403, Shin-Etsu Chemical Co., Ltd., Japan), 0.4 g of leveling agent (BYK360P:BYK362P=1:1, BYK-Chemie GmbH, Germany), and 0.2 g of defoaming agent (BYK141A, BYK-Chemie GmbH, Germany) are put in a mixer. After mixing well, water vapor-proof particles including 16.6 g of first silica particles (sphere with average diameter of 30 μm, KMP-602, Shin-Etsu Chemical Co., Ltd., Japan) and 2.4 g of second silica particles (sphere with average diameter of 100 nm, UFP-30, DENKI KAGAKU KOGYO KABUSHIKI KAISHA Corp., Japan) are added, wherein the mixture is milled by use of a three roll mill for the first time. After the first-time milling is completed, amino-functional curing agents include 16 g of polyamine type curing agent (ARADUR, Huntsman International LLC., U.S.A.) and 4.0 g of composite amino-functional curing agent (EH-4337S, ASATSU-DK INC., Japan) are added, wherein the mixture is milled by use of a three roll mill for the second time. After the second-time milling is completed, the mixture is heated at 80° C. for 30 minutes to obtain a cured epoxy resin composition of the present invention.

[Embodiment 3]

32.2 g of bisphenol-A type epoxy resin (850CRP, DIC Corporation, Japan), 13.8 g of bisphenol-F type epoxy resin (830CRP, DIC Corporation, Japan), 4.0 g of epoxy-alkoxysilane coupling agent (KBM-403, Shin-Etsu Chemical Co., Ltd., Japan), 0.4 g of leveling agent (BYK360P:BYK362P=1:1, BYK-Chemie GmbH, Germany), and 0.2 g of defoaming agent (BYK141A, BYK-Chemie GmbH, Germany) are put in a mixer. After mixing well, water vapor-proof particles including 14.8 g of first silica particles (sphere with average diameter of 30 μm, KMP-602, Shin-Etsu Chemical Co., Ltd., Japan), 2.1 g of second silica particles (sphere with average diameter of 100 nm, UFP-30, DENKI KAGAKU KOGYO KABUSHIKI KAISHA Corp., Japan), 2.1 g of third silica particles (sphere with average diameter of 200-500 nm, DENKI KAGAKU KOGYO KABUSHIKI KAISHA Corp., Japan), and 2.1 g of fourth silica particles (sphere with average diameter of 500-800 nm, UFP-30, DENKI KAGAKU KOGYO KABUSHIKI KAISHA Corp., Japan) are added, wherein the mixture is milled with a three roll mill for the first time. After the first time milling is completed, amino-functional curing agents include 7 g of polyamine type curing agent (ARADUR, Huntsman International LLC., U.S.A.) and 10 g of amino-functional complex curing agent (EH-4337S, ASATSU-DK INC., Japan) are added, wherein the mixture is milled with a three roll mill for the second time. After the second time milling is completed, the mixture is heated at 80° C. for 30 minutes to obtain a cured epoxy resin composition of the present invention.

[Comparison Example 1]

32.2 g of bisphenol-A type epoxy resin (850CRP, DIC Corporation, Japan), 13.8 g of bisphenol-F type epoxy resin (830CRP, DIC Corporation, Japan), 4.0 g of epoxy-alkoxysilane coupling agent (KBM-403, Shin-Etsu Chemical Co., Ltd., Japan), 0.4 g of leveling agent (BYK360P:BYK362P=1:1, BYK-Chemie GmbH, Germany), and 0.2 g of defoaming agent (BYK141A, BYK-Chemie GmbH, Germany) are put in a mixer. After mixing well, water vapor-proof particles including 14.8 g of first silica particles (sphere with average diameter of 30 μm, KMP-602, Shin-Etsu Chemical Co., Ltd., Japan) and 2.1 g of second silica particles (sphere with average diameter of 100 nm, UFP-30, DENKI KAGAKU KOGYO KABUSHIKI KAISHA Corp., Japan) are added, wherein the mixture is milled by use of a three roll mill for the first time. After the first-time milling is completed, 11.5 g of composite amino-functional curing agent (LH-2102, SANWA KAKO Co., Ltd., Japan) is added, wherein the mixture is milled by use of a three roll mill for the second time. After the second-time milling is completed, the mixture is heated at 80° C. for 30 minutes to obtain a cured conventional epoxy resin composition.

[Comparison Example 2]

32.2 g of bisphenol-A type epoxy resin (850CRP, DIC Corporation, Japan), 13.8 g of bisphenol-F type epoxy resin (830CRP, DIC Corporation, Japan), 4.0 g of epoxy-alkoxysilane coupling agent (KBM-403, Shin-Etsu Chemical Co., Ltd., Japan), 0.4 g of leveling agent (BYK360P:BYK362P=1:1, BYK-Chemie GmbH, Germany), and 0.2 g of defoaming agent (BYK141A, BYK-Chemie GmbH, Germany) are put in a mixer. After mixing well, water vapor-proof particles including 14.8 g of first silica particles (sphere with average diameter of 30 μm, KMP-602, Shin-Etsu Chemical Co., Ltd., Japan) and 2.1 g of second silica particles (sphere with average diameter of 100 nm, UFP-30, DENKI KAGAKU KOGYO KABUSHIKI KAISHA Corp., Japan) are added, wherein the mixture is milled by use of a three roll mill for the first time. After the first-time milling is completed, 23 g of polyamine type curing agent (ARADUR, Huntsman International LLC., U.S.A.) is added, wherein the mixture is milled by use of a three roll mill for the second time. After the second-time milling is completed, the mixture is heated at 80° C. for 30 minutes to obtain a cured conventional epoxy resin composition.

[Comparison Example 3]

32.2 g of bisphenol-A type epoxy resin (850CRP, DIC Corporation, Japan), 13.8 g of bisphenol-F type epoxy resin (830CRP, DIC Corporation, Japan), 4.0 g of epoxy-alkoxysilane coupling agent (KBM-403, Shin-Etsu Chemical Co., Ltd., Japan), 0.4 g of leveling agent (BYK360P:BYK362P=1:1, BYK-Chemie GmbH, Germany), and 0.2 g of defoaming agent (BYK141A, BYK-Chemie GmbH, Germany) are put in a mixer. After mixing well, water vapor-proof particles including 14.8 g of first silica particles (sphere with average diameter of 30 μm, KMP-602, Shin-Etsu Chemical Co., Ltd., Japan) and 2.1 g of second silica particles (sphere with average diameter of 100 nm, UFP-30, DENKI KAGAKU KOGYO KABUSHIKI KAISHA Corp., Japan) are added, wherein the mixture is milled by use of a three roll mill for the first time. After the first-time milling is completed, 9.2 g of imidazole curing agent (PN-23, Ajinomoto Fine-Tech., Japan) is added, wherein the mixture is milled by use of a three roll mill for the second time. After the second-time milling is completed, the mixture is heated at 80° C. for 30 minutes to obtain a cured conventional epoxy resin composition.

The compositions of the above embodiments and comparison examples are listed in table 1.

TABLE 1

| | EMBODIMENT | EMBODIMENT | EMBODIMENT | COMPARISON | COMPARISON | COMPARIS [symbol] |
|---|---|---|---|---|---|---|
| g | 1 | 2 | 3 | EXAMPLE 1 | EXAMPLE 2 | EXAMPLE 3 [symbol] |
| Bisphenol-A type | 32.2 | 11.8 | 32.2 | 32.2 | 32.2 | 32.2 |
| epoxy resin | | | | | | |
| Bisphenol-F type | 13.8 | 34.2 | 13.8 | 13.8 | 13.8 | 13.8 |
| epoxy resin | | | | | | |
| Epoxy-alkoxysilane | 4.0 | 4.0 | 4.0 | 4.0 | 4.0 | 4.0 |
| Leveling agent | 0.4 | 0.4 | 0.4 | 0.4 | 0.4 | 0.4 |
| Defoaming agent | 0.2 | 0.2 | 0.2 | 0.2 | 0.2 | 0.2 |
| First | 16.6 | 16.6 | 14.8 | 16.6 | 16.6 | 16.6 |
| silica particles | | | | | | |
| Second | 2.4 | 2.4 | 2.1 | 2.4 | 2.4 | 2.4 |
| silica particles | | | | | | |
| Third | 0 | 0 | 2.1 | 0 | 0 | 0 |
| silica particles | | | | | | |
| Fourth | 0 | 0 | 2.1 | 0 | 0 | 0 |
| silica particles | | | | | | |
| Composite amino- | 4.0 | 4.0 | 7.0 | 11.5 | 0 | 0 |
| functional | | | | | | |
| curing agent | | | | | | |
| Polyamine type | 16.0 | 16.0 | 10.0 | 0 | 23.0 | 0 |
| curing agent | | | | | | |
| Imidazole | 0 | 0 | 0 | 0 | 0 | 9.2 |
| curing agent | | | | | | |

[symbol]

indicates data missing or illegible when filed

Hardening observation, glass transition temperature measurement, water vapor transmission rate (WVTR) measurement, and storage stability test are performed on the epoxy resin compositions of the above embodiments and comparison examples. The glass transition temperature (Tg) measurement is performed by a Differential Scanning calorimeter (Q100, TA Instruments, U.S.A.), wherein the measurement is carried by raising the temperature of the epoxy resin composition from −50° C. to 150° C. with a raising rate of 20° C./min, and the glass transition temperature is determined by the temperature rising curve. The WVTR measurement is performed by a WVTR tester (AQUTRAN Model-1, MOCON Co. Ltd., U.S.A.), wherein a 0.5 cm² epoxy resin composition film having a thickness of 160 μm is disposed in the chamber of the WVTR tester at 40° C. and 90% RH and is the WVTR measured after an equilibrium is reached. The storage stability test is performed by observing the viscosity change over time. The viscosity is measured by a rheometer (AR2000ex, TA instruments). The measured viscosity of a newly prepared epoxy resin composition is represented as Vis.(0 hr), wherein the measured viscosity of an epoxy resin composition stored at room temperature (25° C.) for 24 hours is represented as Vis.(24 hr). A viscosity increment rate is defined as a value obtained by dividing the Vis.(24 hr) by the Vis.(0 hr), wherein the storage stability is determined “good” when the viscosity incensement rate is lower than 1.2. A deflection test is performed in accordance with IPC-650 Substrate Curvature: Silicon Wafers with Deposited Dielectrics. The results of the above mentioned tests and measurements are listed in table 2.

TABLE 2

| | EMBODIMENT | EMBODIMENT | EMBODIMENT | COMPARISON | COMPARISON | COMPAR [symbol] |
|---|---|---|---|---|---|---|
| | 1 | 2 | 3 | EXAMPLE 1 | EXAMPLE 2 | EXAMPL [symbol] |
| Hardened | Yes | Yes | Yes | No | Yes | Yes |
| Tg | 51 | 37 | 54 | — | 71 | 83 |
| WVTR (g/m² day) | 19.2 | 21.6 | 17.3 | — | 20.7 | 20.3 |
| Vis.(0 hr)(Pa · S) | 27.99 | 21.41 | 26.32 | 23.40 | 33.96 | 20.37 |
| Vis.(24 hr)(Pa · S) | 25.92 | 19.48 | 26.49 | 22.93 | 31.58 | 24.65 |
| viscosity | 0.93 | 0.91 | 1.01 | 0.98 | 0.93 | 1.21 |
| incensement rate | | | | | | |
| deflection | Good | Good | Good | — | Poor | Very P [symbol] |

[symbol]

indicates data missing or illegible when filed

As shown in table 2, the cured epoxy resin composition of the present invention (EMBODIMENTS 1-3) has low WVTR (i.e. good water vapor resistance), good storage stability, low glass transition temperature, and good deflection.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An epoxy resin composition having a glass transition temperature between 20° C. and 75° C., comprising:
an epoxy resin;
a plurality of water vapor-proof particles; and
at least two kinds of amino-functional curing agents, wherein one of the amino-functional curing agents is a polyamine-type curing agent.

2. The epoxy resin composition of claim 1, wherein the weight percent of the amino-functional curing agents corresponding to the epoxy resin is between 10% and 95%.

3. The epoxy resin composition of claim 1, wherein the weight percent of the amino-functional curing agents corresponding to the epoxy resin is between 12% and 80%.

4. The epoxy resin composition of claim 1, wherein the weight percent of the amino-functional curing agents corresponding to the epoxy resin is between 15% and 60%.

5. The epoxy resin composition of claim 1, wherein the weight percent of the polyamine-type curing agent corresponding to the amino-functional curing agents is between 30% and 95%.

6. The epoxy resin composition of claim 1, wherein the weight percent of the polyamine-type curing agent corresponding to the amino-functional curing agents is between 35% and 90%.

7. The epoxy resin composition of claim 1, wherein the weight percent of the polyamine-type curing agent corresponding to the amino-functional curing agents is between 40% and 85%.

8. The epoxy resin composition of claim 1, wherein the amino-functional curing agents further include a composite amino-functional curing agent.

9. The epoxy resin composition of claim 1, wherein the water vapor-proof particle is selected from the group consisting of silica, aluminum oxide, clay, mica, and a combination thereof.

10. The epoxy resin composition of claim 1, wherein the plurality of water vapor-proof particles include:
a plurality of first silica particles having an average diameter of 30 μm; and
a plurality of second silica particles having an average diameter of 100 nm.

11. The epoxy resin composition of claim 10, wherein the weight percent of the second silica particles corresponding to the first silica particles is between 0.1% and 50%.

12. The epoxy resin composition of claim 10, wherein the weight percent of the second silica particles corresponding to the first silica particles is between 1% and 40%.

13. The epoxy resin composition of claim 10, wherein the plurality of water vapor-proof particles further include a plurality of third silica particles having an average diameter between 200 nm and 500 nm, wherein the weight percent of the third silica particles corresponding to the first silica particles is between 0.1% and 50%.

14. The epoxy resin composition of claim 13, wherein the plurality of water vapor-proof particles further include a plurality of fourth silica particles having an average diameter between 500 nm and 800 nm, wherein the weight percent of the fourth silica particles corresponding to the first silica particles is between 0.1% and 50%.

15. The epoxy resin composition of claim 1, further comprising a coupling agent, a leveling agent, and a defoaming agent.

16. The epoxy resin composition of claim 1, wherein the epoxy resin is selected from the group consisting of bisphenol-A type epoxy resin, bisphenol-F type epoxy resin, and a combination thereof.

17. An epoxy resin composition having a glass transition temperature between 20° C. and 75° C., comprising:
an epoxy resin;
a plurality of silica particles, including:
a plurality of first silica particles having an average diameter of 30 μm; and
a plurality of second silica particles having an average diameter of 100 nm.; and
at least two kinds of amino-functional curing agents, wherein one of the amino-functional curing agents is a polyamine-type curing agent.

18. The epoxy resin composition of claim 17, wherein the plurality of silica particles further include a plurality of third silica particles having an average diameter between 200 nm and 500 nm, wherein the weight percent of the third silica particles corresponding to the first silica particles is between 0.1% and 50%.

19. The epoxy resin composition of claim 17, wherein the plurality of silica particles further include a plurality of fourth silica particles having an average diameter between 500 nm and 800 nm, wherein the weight percent of the fourth silica particles corresponding to the first silica particles is between 0.1% and 50%.
